(19) United States
(12) Patent Application Publication
(10) Pub. No.: US 2014/0113099 A1
(43) Pub. Date: Apr. 24, 2014

(54) THREE DIMENSIONAL NON-INFLATABLE FLOATING DISPLAY APPARATUS

(71) Applicant: Gary Arnett, Ontario, CA (US)

(72) Inventor: Gary Arnett, Ontario, CA (US)

(21) Appl. No.: 13/658,914

(22) Filed: Oct. 24, 2012

(51) Int. Cl. G09F 19/00; B32B 3/02; B32B 37/00; B63B 35/73

(52) U.S. Cl. 428/80; 441/129; 29/428

(57) ABSTRACT

In accordance with one embodiment, colored foam especially adapted for displaying three-dimensional display apparatus that is also capable of being used as a flotation device is envisioned. In one embodiment, the colored foam is ethylene-vinyl acetate (EVA), although other types of expanded plastics such as polystyrene are also contemplated. In one embodiment, the display apparatus consists of logos and/or names of sports teams, such as professional or collegiate football, baseball, soccer, and basketball teams.

### CROSS-REFERENCE TO RELATED APPLICATIONS

This application claims the benefit of U.S. Provisional Application No. 61/557,535, filed on Nov. 9, 2011.

### BACKGROUND

The following is a tabulation of some prior art that presently appears relevant:

U.S. Patents

| Pat. No. | Kind Code | Issue Date | Patentee |
|---|---|---|---|
| 6,000,063 | A | Dec. 14, 1999 | Sullivan |
| 6,108,817 | A | Aug. 29, 2000 | Kostelac |
| 8,141,281 | B2 | Mar. 27, 2012 | Sample |

U.S. Patent Application Publications

| Publication Number | Kind Code | Publ. Date | Applicant |
|---|---|---|---|
| 2007/0277286 | A1 | Dec. 6, 2007 | Gleeson |

Foreign Patent Document
None found
Nonpatent Literature Documents
None found

### NOTICE OF COPYRIGHT AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### DISCUSSION OF THE RELATED ART

Ethylene vinyl acetate (EVA) is the copolymer of ethylene and vinyl acetate. This polymer exhibits the softness and flexibility of elastomeric materials, yet can be processed in a similar manner to other thermoplastics.

The properties inherent to EVA make it an ideal polymer for a variety of uses ranging from drug delivery in the field of biomedical engineering to recreational uses including the production of surfboards. The material has good clarity and gloss, barrier properties, low-temperature toughness, stress-crack resistance, hot-melt adhesive waterproof properties, and resistance to UV radiation. EVA has little or no odor and is sometimes used to replace rubber and vinyl in a variety of different applications.

In the area of competitive sports, athletic teams have a logo or name by which they are identified by fans of the sport. For example, it is well known to identify with the baseball team who plays their home games in Los Angeles as the “Dodgers” or in the case of basketball, the “Lakers” and the “Clippers.”

It is common for sports fans to show support for a particular athletic team at a sporting event or in their homes by exhibiting their favorite team logos. Accordingly, various types of display apparatus such as the “Hand-Shaped Novelty Hand Sign” disclosed in U.S. Pat. No. 6,108,817 issued to Kostelac, the “Display Appatuses” disclosed in U.S. Pat. No. 8,141,281 issued to Sample, or the “Novelty Sports Hat with Three-Dimensional Team Insignia” disclosed in U.S. Pat. No. 6,000,063 issued to Sullivan.

In addition, numerous visual motivation devices have been utilized such as flags, banners, pennants, towels, and the like which, when waved are effective ways of motivating a sports fan's team. Similarly, posters, free-standing cardboard cut-outs, wall-clinging decals i.e. Fatheads®, and the like have traditionally been used by fans to show support for their favorite teams.

Even though team logo novelty apparatus have been proposed in the past, all of the those heretofore known suffer from a number of disadvantages:
(a) the known novelty apparatus are not three dimensional;
(b) the known novelty apparatus are not water resistant;
(c) the known novelty apparatus cannot be used both indoors and outdoors;
(d) the known novelty apparatus are not resistant to ultraviolet light;
(e) the known novelty apparatus cannot be used as a floating ornament which can also be decorative when removably mountable to a variety of surfaces; and
(f) the known novelty apparatus do not comprise all of the advantageous properties of EVA foam.

Various apparatus for exhibiting spectator support have been proposed. However, none of the foregoing combine the characteristics of the present invention. Therefore, there is a need for a three dimensional floating display apparatus that is durable enough for users to display in a variety of environments while being light enough to mount on a wall or float in a swimming pool. The present invention effectuates these needs.

### SUMMARY

A novelty floating display apparatus for promoting fan spirit by encouraging fans to actively participate through visual motivation. Said display apparatus is comprised of at least two layers of foam stacked on top of one another so as to allow the bottom layer to be partially visible when viewed from the top. The various layers of the display apparatus may be shaped to resemble teams logos, names, slogans, or the like such that the spectator can communicate his or her support for a team.

In accordance with one embodiment, colored foam especially adapted for displaying three-dimensional display apparatus that is also capable of being used as a flotation device is envisioned. In one embodiment, the colored foam is ethylene-vinyl acetate (EVA), although other types of expanded plastics such as polystyrene are also contemplated. In one embodiment, the display apparatus consist of logos and/or names of sports teams, such as professional or collegiate football, baseball, soccer and basketball teams. However, it is further envisioned that the display apparatus may be indicia of another type such as company mascots. Examples of such other indicia include Mickey Mouse® or the Harley Davidson® emblem. However, the logos and team names of other sports teams, whether at the professional, collegiate, high school or other level are all contemplated.

It is further envisioned that the foam may be produced in a variety of different colors. By way of example, and not as a limitation, the basic colors might include blue, red, and gold. Several basic colors will match the prominent color of specific professional and/or collegiate sports teams logo, or other similar indicia including cartoon characters.

In one embodiment, the different colored foams are cut and stacked on top of one another to recreate the look of a particular logo. For example, the high school team the “Bulldogs” have a snarling dog's face as their logo. The primary colors found in the logo are black, grey, red, and white. As a result, in this instance, four different colored foams would be used to create the three-dimensional foam floating display apparatus.

Each color would then be cut to reflect various parts of the team logo. For example, the white could be cut in the shape of the dog's teeth as well as the whites of its eyes. The grays could be cut into the shape of the dog's face and spikes in its collar. The black pieces are cut into various shapes to outline parts of the dog's face such as cheeks and the ears.

It is envisioned that in one embodiment, the various cut pieces of foam may be stacked on top of one another to make a three-dimensional version of a particular logo. In yet another embodiment, all of the three-dimensional logos would have at least one base layer of foam that is thicker than all of the rest. The base layer is the one upon which all the thinner layers would rest. The base layer would also be the layer immersed in water when the floating apparatus is being used as a floatation device. The additional thickness of the base layer gives it the buoyancy it needs to keep the apparatus from becoming completely submerged in water.

In one embodiment of the flotation apparatus, the outer edges of the base layer would protrude from the sides establishing an outline for the logo. In this instance, the base layer of foam would be the same color as the outline of a particular team or companies indicia. By way of example, the base layer in a three-dimensional foam Anaheim “Angels” logo would be blue. In the case of the “Bulldogs,” the base layer may be a different color.

In yet another embodiment, all of the subsequent layers would be at least half the thickness of the base layer. Each three-dimensional display apparatus will be comprised of at least two layers and, whenever necessary, the subsequent layers would be cut in such a way so as to allow the colors of the preceding layer to remain visible.

### Advantages

Thus several advantages of one or more aspects are to provide a three dimensional foam flotation apparatus that:
(a) is water resistant;
(b) can be used both indoors and outdoors;
(c) that is resistant to ultraviolet radiation;
(d) can be used as a non-inflatable flotation device which may also be removably mounted and displayed on a surface such as a wall; and
(e) comprises all of the advantageous properties of EVA foam.

These and other advantages of one or more aspects will become apparent from consideration of the ensuing description and accompanying drawings. Although the description above contains many specificities, these should not be construed as limiting the scope of the embodiments but as merely providing illustrations of some of several embodiments. Thus the scope of the embodiments should be determined by the claims that are appended and their legal equivalents, rather than by the examples given.

The description of the invention which follows, together with the accompanying drawings should not be construed as limiting the invention to the example shown and described, because those skilled in the art to which this invention pertains will be able to devise other forms thereof within the ambit of the appended claims.

### DESCRIPTION OF THE DRAWINGS

### Figures

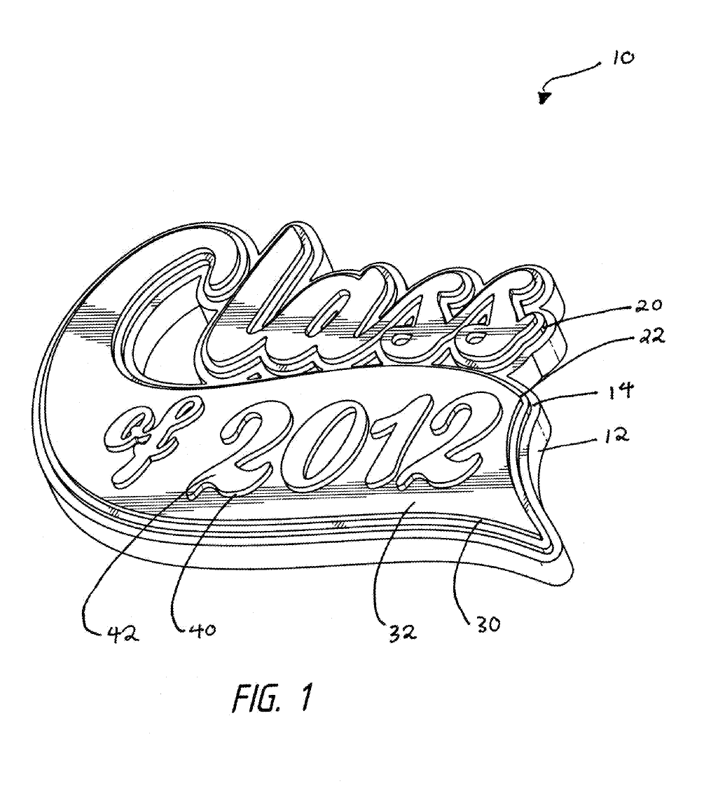

FIG. 1 is a perspective view of a three-dimensional non-inflatable floating foam display apparatus in a “Class of 2012” embodiment;

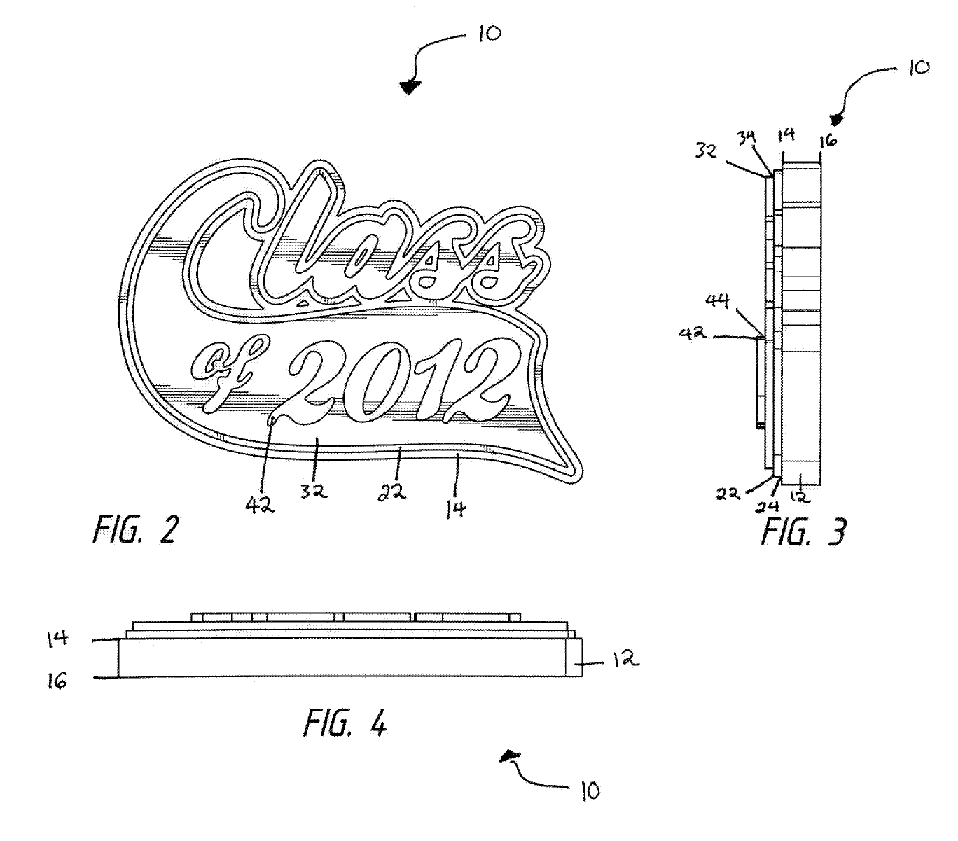

FIG. 2 is a top view of the same display apparatus as in FIG. 1;

FIG. 3 is a right side view of the same display apparatus as in FIG. 1;

FIG. 4 is a bottom side view of the same display apparatus as in FIG. 1;

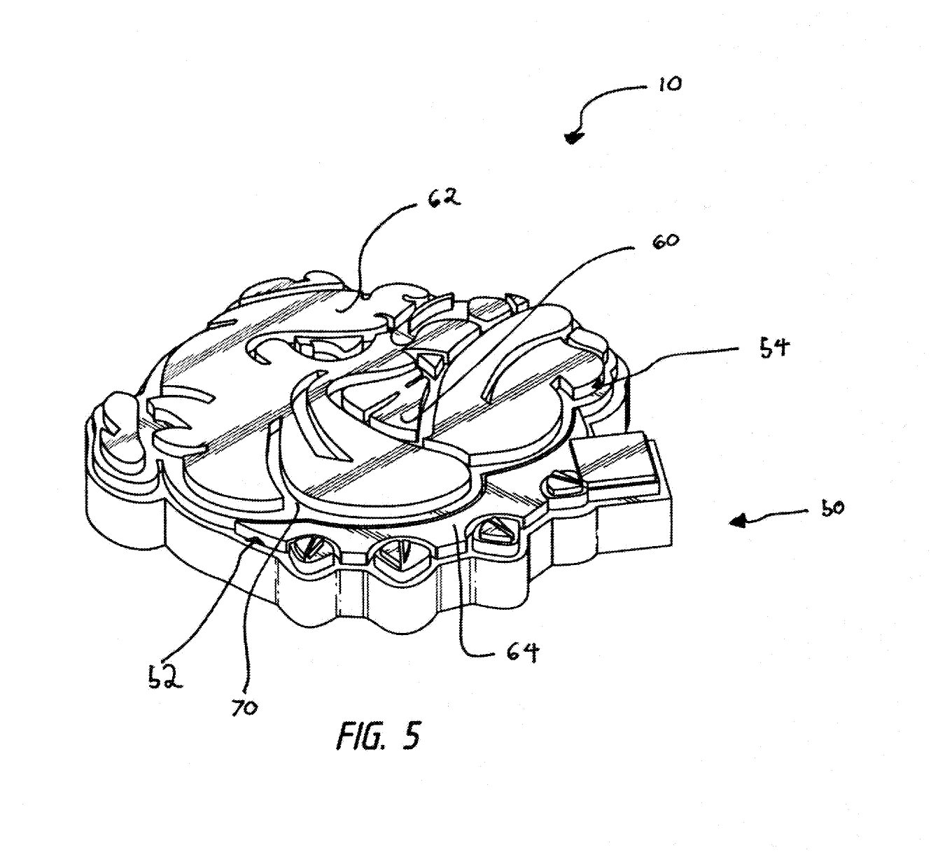

FIG. 5 is a perspective view of a three-dimensional non-inflatable floating foam display apparatus in a bulldog embodiment;

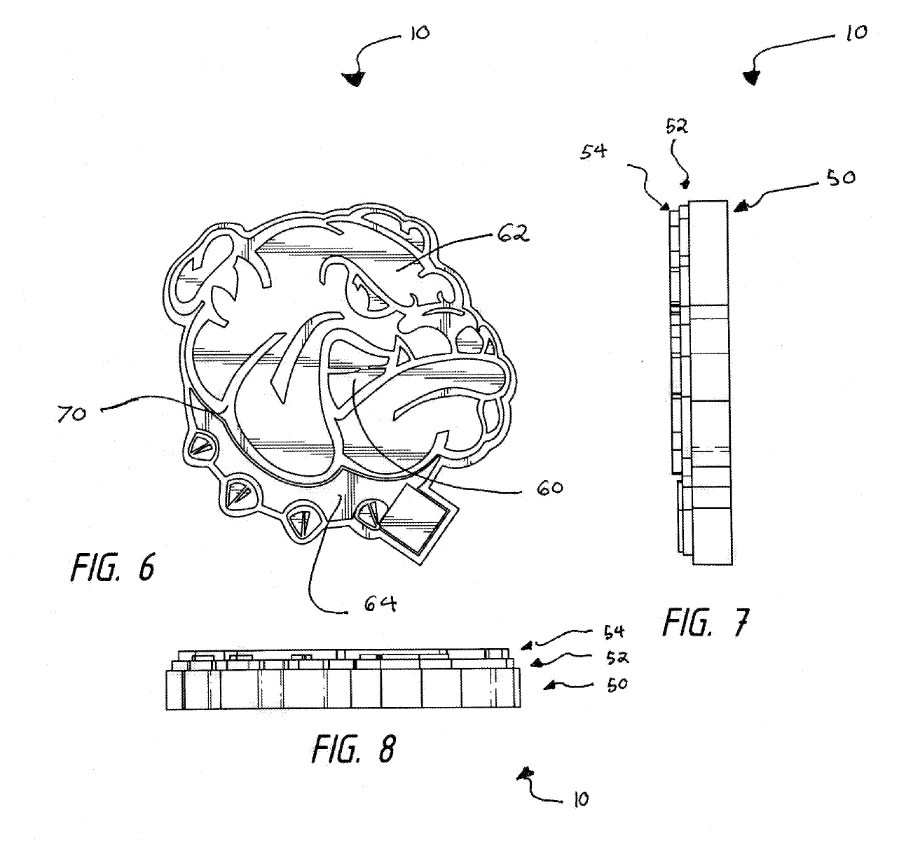

FIG. 6 is a top view of the same display apparatus as in FIG. 5;

FIG. 7 is a right side view of the same display apparatus as in FIG. 5; and

FIG. 8 is a bottom side view of the same display apparatus as in FIG. 5.

Reference Numerals

| | | | |
|---|---|---|---|
| 10 | novelty display apparatus | 12 | base layer |
| 14 | base layer front panel | 16 | base layer back panel |
| 20 | second layer | 22 | second layer front panel |
| 24 | second layer back panel | 30 | third layer |
| 32 | third layer front panel | 34 | third layer back panel |
| 40 | fourth layer | 42 | fourth layer front panel |
| 44 | fourth layer back panel | 50 | bulldog base level |
| 52 | bulldog intermediate level | 54 | bulldog third level |
| 60 | bulldog teeth | 62 | bulldog face |
| 64 | bulldog collar | 70 | third level/second level gap |

### DETAILED DESCRIPTION

Illustrative embodiments of the invention are described below. The showings are for purposes of illustrating preferred embodiments and not for purposes of limiting the same. The following explanation provides specific details for a thorough understanding of an enabling description for these embodiments. One skilled in the art will understand that the invention may be practiced without such details. In other instances, well-known structures and functions have not been shown or described in detail to avoid unnecessarily obscuring the description of the embodiments.

As illustrated in FIGS. 1-4 the three dimensional floating display apparatus may be shaped to display a students graduation year or may be shaped to look like a team mascot as in FIGS. 5-8. While the figures display two different floating apparatus, it is not necessary that the floating apparatus be in the shape of a bulldog face or read the “Class of 2012.” These three dimensional signs may be shaped to resemble any number of team logo, cartoon characters, company trademarks, or other like indicia.

FIGS. 1-4 illustrate the “Class of 2012” example of a floating display apparatus including a plurality of layers of foam each foam layer having a top surface and a bottom surface. The base layer 12 is a one piece foam member that can be shaped to form an outline of the “Class of 2012” indicia. This layer is comprised of a front panel 14 and a back panel 16. There are no words on this layer 12, just a thick layer of foam which will make the apparatus buoyant enough to float. In one embodiment, the base layer 12 of the apparatus will be the widest layer of the apparatus 10. This will enable the base layer 12 to form an outline for the indicia on the apparatus 10.

As illustrated in FIGS. 1 & 2, the second layer 20 may be shaped as a slightly smaller version of the base layer 12. Doing so will allow the sides of the base layer 12 to protrude creating the effect of an outline and giving particular visual characteristics to the apparatus 10. This has an especially dramatic effect when the second layer 20 is a different color than the base layer 12.

The base layer front 14 and the second layer back 24 are stacked together in compressive engagement to form a stack. The two layers may be secured together using a number of different methods. The bond must be so strong that the layers remain in tact even when the apparatus 10 is being hung from a wall. The bond must also be water resistant so that when the apparatus 10 is immersed in water or is floating in a swimming pool, the apparatus 10 remains in tact. The bond may be formed using glue, heat sealed, or other suitable method for achieving a strong, water-tight seal.

In this embodiment, the second layer 20, unlike the base layer 12, comprises the word “Class” instead of being just an outline for the indicia on the apparatus 10. Accordingly, the indicia starts to become recognizable through the addition of the second layer 20.

Still referring to the “Class of 2012” embodiment illustrated in FIGS. 1-4, which comprises a third layer 34 having a front panel 32 and a back panel 34. This layer 30 is not as wide or as high as the second layer 20. That allows the outline of the second layer front panel 22 to remain visible even once the third layer 30 is stacked on top of it. The visual impact is enhanced by using a different color foam for the second layer 20 and the third layer 30.

The second layer front 22 and the third layer back 34 are stacked together in compressive engagement to form a stack. The two layers may be secured together using a number of different methods. The bond must be so strong that the layers remain in tact even when the apparatus 10 is being hung from a wall. Again, this bond must also be water resistant so that when the apparatus 10 is immersed in water or is floating in a swimming pool, the apparatus 10 remains in tact. Those of reasonable skill in the art will realize the bond may be formed using glue, heat sealed, or other suitable method for achieving a strong, water-tight seal.

In this embodiment, the third layer 30, unlike the base layer 12, comprises the word “Class” instead of being just an outline for the indicia on the apparatus 10. Moreover, there is more detail in this layer than in the preceding second layer 20. Accordingly, the “Class” indicia is completely recognizable through the addition of the third layer 30.

Finally, still referring to FIGS. 1-4, the fourth layer 40 of the apparatus 10 comprises the words and number “of 2012.” This layer comprises a front panel and a back panel. The third layer front 32 and the fourth layer back 44 are stacked together in compressive engagement to form a stack. The two layers may be secured together using a number of different methods. The bond must be so strong that the layers remain in tact even when the apparatus 10 is being hung from a wall. Once again, this bond must also be water resistant so that when the apparatus 10 is immersed in water or is floating in a swimming pool, the apparatus 10 remains in tact. The bond may be formed using glue, heat sealed, or other suitable method for achieving a strong, water-tight seal.

In one embodiment of the apparatus 10, the words and numbers “of 2012” are a different color than the third layer 30. Now, the novelty flotation apparatus 10 clearly reads “Class of 2012” in a creative, beautiful, and useful way.

The apparatus may be comprised of multiple layers depending on the shape of the indicia and the preference of the user. In FIGS. 5-8, the bulldog head is an example of the mascot embodiment of the apparatus. Each individual layer is of a thickness between approximately one and six centimeters. Again, one of ordinary skill in the art would recognize that layers of other thickness and densities could be used so long as the effectiveness of the flotation apparatus is not compromised.

Unlike the “Class of 2012” embodiment displayed in FIGS. 1-4, the bulldog head shown in FIGS. 5-8 comprises a variety of different colored foams on the same level. By way of example, referring now to FIGS. 5-8, white colored foam may be used in the third level 54 of the bulldog-shaped apparatus to capture the bulldog's teeth 60. The added amount of detail in the bulldog's face as compared to the “Class of 2012” indicia, makes necessary the use of a variety of different color, size, and shape foams for use within a given level to capture all of the intricacies of the bulldog's face. Nevertheless, it remains important that the base layer 50 be thick enough to support at least the weight of the apparatus and avoid complete submersion when placed in water.

In the interest of clarity, the bulldog face will be described as being comprised of three different levels as opposed to layers. These are the base level 50, the intermediate level 52, and the third level 54. Those of ordinary skill in the art will recognize the possibility of utilizing more levels or less levels depending on the intricacy of the indicia.

Spacing of pieces in the third level 54 and color choice are important features of the apparatus 10. The bulldog-shaped apparatus 10 may comprise different colored foam pieces in the third level 54 in order to distinguish the bulldog face 62 from the bulldog collar 64.

Using a different color for the intermediate level 52 than any of the pieces 60, 62, etc. in the third level 54 can have a dramatic visual effect on the apparatus 10. Like with the “Class of 2012” apparatus in FIGS. 5-8, the intermediate level 52 foam may be a similar shape as the base level 50 just less wide, not as tall, and also lacking details of the indicia represented on the apparatus 10. The spaces 70 where the third level pieces 60, 62, etc. do not cover the intermediate level 52 create the unique visual effect of an outline around particular parts of the apparatus 10. This is especially impactful when the color contrast between the levels 52 & 54 is significant. For example when the intermediate level 52 is black and the third level pieces 60, 62, etc. are light colors such as white and gray.

The techniques used to capture the bulldog mascot indicia on the version of the apparatus 10 displayed in FIGS. 5-8, can be used to recreate any number of mascots, cartoon characters, company logos, and the like. By way of example and not limitation, Mickey Mouse®, the Batman® emblem, and the Denver Broncos® logo, etc.

In another embodiment not displayed here, the apparatus 10 may also be shaped to capture slogans such as the letter “D” followed by a three dimensional foam fence with a team logo or mascot on it. The “Defense” embodiment could then be held up during sporting events as a show of support for a particular team.

In one embodiment of the apparatus 10 the base layer 12 will be at least twice the thickness of the second layer 20. In the “Class of 2012” embodiment used as an example in FIGS. 1-4, the base layer is approximately six centimeters thick where as all of the subsequent layers are between one centimeter and one and a half centimeters thick, the additional thickness of the base layer gives it the buoyancy it needs to keep the apparatus 10 from becoming completely submerged in water. Accordingly, the thickness of each layer can vary depending on the shape and size of the apparatus 10.

In one embodiment, the layers of foam may be made of ethylene-vinyl acetate (EVA), although any other flexible or rigid cellular plastics may be employed. Given the inherent durability of this type of foam and the fact that it is immune from the sort of pin hole punctures that would sink an inflatable floating apparatus, EVA is very useful as a foam for the disclosed apparatus 10. EVA is lightweight while allowing for flexibility and strength. It is readily available and can resist UV light and pool chemicals. However, one of ordinary skill in the art would recognize that other materials could be substituted without departing form the spirit and scope of the floatation apparatus including polyurethane, polyethylene, vinyl polymers, polystyrene, epoxy and polyvinyl chloride.

In one embodiment of the three dimensional foam apparatus 10, holes may be placed in the base layer back panel 16 to make it easier to hang on a wall. A nail or screw may then be placed through the hole to facilitate hanging the apparatus 10. The holes are optional features and not a necessary part of the apparatus 10.

Finally, the base layer or level and all subsequent layers or levels may be integrally colored with a variety of colors. In one embodiment, entire apparatus 10 may be covered in luminescent film or paint that will glow in the dark.

### CONCLUSIONS, RAMIFICATIONS, AND SCOPE

While a particular form of the invention has been illustrated and described, it will be apparent that various modifications can be made without departing from the spirit and scope of the invention. For example, the floating apparatuses are shown as a bulldog face and the “Class of 2012” even though the inventor contemplates the possibility that the display apparatus may take the shape of different professional sport team logos, slogans, cartoon characters or other like marks. Accordingly, is not intended that the invention be limited, except as by the appended claims.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Particular terminology used when describing certain features or aspects of the invention should not be taken to imply that the terminology is being refined herein to be restricted to any specific characteristics, features, or aspects of the foam flotation apparatus with which that terminology is associated. In general, the terms used in the following claims should not be constructed to limit the foam floating apparatus to the specific embodiments disclosed in the specification, unless the above description section explicitly define such terms. Accordingly, the actual scope encompasses not only the disclosed embodiments, but also all equivalent ways of practicing or implementing the disclosed foam apparatus. The above description of embodiments of the foam floating apparatus is not intended to be exhaustive or limited to the precise form disclosed above or to a particular field of usage. While specific embodiments of, and examples for, the foam floating apparatus are described above for illustrative purposes, various equivalent modifications are possible which those skilled in the relevant art will recognize.

While certain aspects of the foam floating apparatus are presented below in particular claim forms, the inventor contemplates the various aspects of the foam floating apparatus in any number of claim forms. Accordingly, the inventor reserves the right to add additional claims after filing the application to pursue such additional claim forms for other aspects of the foam floating apparatus.

What is claimed is:

1. A novelty non-inflatable floating display apparatus to be disposed by user when showing support for a particular sporting organization comprising:
at least two layers namely a first layer and a second layer;
said first layer being of a different color than said second layer;
said first layer comprising a top panel and a bottom panel having a three-dimensionally contoured shape;
and said second layer comprising a top panel and a bottom panel having a three-dimensionally contoured shape; and
said first layer top panel to be permanently affixed to said second layer bottom panel so as to form a waterproof seal;
the apparatus being configured for use as a flotation device.

2. The apparatus of claim 1 further comprising a third layer said third layer comprising a top panel and a bottom panel having a three-dimensionally contoured shape; and
said second layer top panel to be permanently affixed to said third layer bottom panel so as to form a waterproof seal.

3. The apparatus of claim 2 further comprising a fourth layer said fourth layer comprising a top panel and a bottom panel having a three-dimensionally contoured shape; and
said third layer top panel to be permanently affixed to said fourth layer bottom panel so as to form a waterproof seal.

4. A novelty non-inflatable floating display apparatus to be disposed by user when showing support for a particular sporting organization comprising:
at least two layers namely a first layer and a second layer;
said first layer being of a different color than said second layer;
said first layer comprising a top panel and a bottom panel having a three-dimensionally contoured shape;
and said second layer comprising a top panel and a bottom panel having a three-dimensionally contoured shape; and
said first layer top panel to be permanently affixed to said second layer bottom panel so as to form a waterproof seal;
the apparatus being configured to be removably mounted to a wall when not in use.

5. The apparatus of claim 4 further comprising a third layer said third layer comprising a top panel and a bottom panel having a three-dimensionally contoured shape; and
said second layer top panel to be permanently affixed to said third layer bottom panel so as to form a waterproof seal.

6. The apparatus of claim 5 further comprising a fourth layer said fourth layer comprising a top panel and a bottom panel having a three-dimensionally contoured shape; and
said third layer top panel to be permanently affixed to said fourth layer bottom panel so as to form a waterproof seal.

7. A method of producing a novelty non-inflatable floating display apparatus to be disposed by user when showing support for a particular sporting organization comprising the steps of:
(a) providing at least two layers namely a first layer and a second layer, said first layer having a top panel and bottom panel, and said second layer having a top panel and a bottom panel, and said second layer being of a different color than said first layer, said first layer having a three-dimensionally contoured shape and said second layer having a three-dimensionally contoured shape; and
(b) affixing said first layer top panel to said second layer bottom panel so as to form a water proof seal.

8. The method of claim 7 further comprising the steps of:
(a) providing a third layer having a top panel and a bottom panel, said third layer being of a different color than said second layer, said third layer having a three-dimensionally contoured shape; and
(b) affixing said second layer top panel to said third layer bottom panel so as to form a water proof seal.

9. The method of claim 8 further comprising the steps of:
(a) providing a fourth layer having a top panel and a bottom panel, said fourth layer being of a different color than said third layer, said fourth layer having a three-dimensionally contoured shape; and
(b) affixing said third layer top panel to said fourth layer bottom panel so as to form a water proof seal.
